(19) United States
(12) Patent Application Publication
(10) Pub. No.: US 2020/0202079 A1
(43) Pub. Date: Jun. 25, 2020

(54) TEXT GENERATION METHOD, TEXT GENERATION DEVICE, AND LEARNING-COMPLETED MODEL

(71) Applicant: Hitachi, Ltd., Tokyo (JP)

(72) Inventors: Kenichi YOKOTE, Tokyo (JP); Makoto IWAYAMA, Tokyo (JP)

(21) Appl. No.: 16/718,272

(22) Filed: Dec. 18, 2019

(30) Foreign Application Priority Data
Dec. 25, 2018 (JP) 2018-241388

(51) Int. Cl. G06F 40/56; G06F 40/211; G06F 40/247; G06N 3/04; G06N 3/08; G06N 20/00

(52) U.S. Cl. CPC G06F 40/56; G06F 40/211; G06N 20/00; G06N 3/0454; G06N 3/08; G06F 40/247

(57) ABSTRACT

A replacement information collection unit determines a role of an auxiliary replacer; an auxiliary replacer teacher data generation unit generates replacement teacher data used for machine learning of the auxiliary replacer based on a reference result of a replacement information DB; an auxiliary replacer generation unit generates the auxiliary replacer based on a replacement teacher data DB; an auxiliary replacer and text generator coupling unit couples the auxiliary replacer generated by the auxiliary replacer generation unit with a text generator that has not performed learning; a text generation information collection unit collects before-generation information and after-generation information of a text; a text generator teacher data generation unit generates generation teacher data used for machine learning of the text generator based on a reference result of a generation information DB; and a text generator generation unit generates a text generator based on a generation teacher data DB.

### INCORPORATION BY REFERENCE

This application claims priority based on a Japanese patent application, No. 2018-241388 filed on Dec. 25, 2018, the entire contents of which are incorporated herein by reference.

### BACKGROUND

The subject matter discussed herein relates to a text generation method, a text generation device, and a learning-completed model.

Natural language processing is required for many systems to recognize whether meaning or intent of two texts is the same. For example, a question answering system is considered which stores a question sentence and an answer sentence as a pair, receives an input from a user, searches for a question sentence corresponding to the input, and then outputs an answer corresponding to the question sentence.

A text of the input from the user is not necessarily the same text as the question sentence stored in the question answering system. Even when the question answering system stores a question sentence of “Please tell me the location of the station” and an answer sentence of “It is 200 meters to the north” as a pair, a text of “I want to know the location of the station” instead of the text of “Please tell me the location of the station” may be input from the user. In response to the input of “I want to know the location of the station”, the question answering system cannot answer that “It is 200 meters to the north” in a case where the question answering system determines whether the text of “I want to know the location of the station” completely matches with the text of “Please tell me the location of the station” and searches the answer sentence corresponding to the text of “Please tell me the location of the station”.

Without being limited to the case described above, in a case of a variation of an inflectional form, or a case where another word with the same meaning is input, the question answering system cannot associate the input from the user with the corresponding question sentence despite the question answering system stores the answer sentence.

One of methods for solving such a problem is paraphrase generation (Paraphrase Generation). Paraphrase generation is a technique for generating, when a certain text is given, another text having the same meaning. By performing the paraphrase generation and associating a plurality of question sentences with one answer sentence, the question answering system can answer various inputs.

Paraphrase Generation with Deep Reinforcement Learning Zichao Li, Xin Jiang, Lifeng Shang, Hang Li, EMNLP 2018 (Non-Patent Literature 1), Neural Paraphrase Generation with Stacked Residual LSTM Networks Aaditya prakash, Sadid A. Hasan, Kathy Lee, Vivekdatla, Ashequl Qadir, Joey Liu, Oladimeji Farri, COILING 2016 (Non-Patent Literature 2), and Joint Copying and Restricted Generation for Paraphrase Ziqiang Cao, Chuwei Luo, Wenjie Li, Sujian Li, AAAI 2017 (Non-Patent Literature 3) disclose a method for performing paraphrase generation by an End-to-End architecture that is based on a neural network. For example, in a case where only a part of verbs in a text are replaced as in processing of generating “I want to know the location of the station” from “I want to confirm the location of the station”, learning data can be automatically constructed by using a synonym dictionary or the like and the processing desired to be realized is not complicated, and thus compatibility with the End-to-End architecture is good.

However, for example, in a case where words and style of the text are changed as in processing of generating “I want to take the train” from “Where is the station”, the processing desired to be realized is complicated, a large amount of learning data is required and it is difficult to automatically construct the learning data, and thus the compatibility with the End-to-End architecture is poor.

### SUMMARY

The invention has been made in view of the circumstances described above, and an object of the invention is to provide a text generation method, a text generation device, and a learning-completed model which are capable of coping with the complication of processing while reducing the difficulty of constructing learning data.

In order to achieve the object described above, a text generation method according to a first aspect of the invention is provided which includes the steps of: generating an auxiliary replacer that is made to learn pairs of elements obtained by segmenting a text; generating a text generator that is made to learn texts before and after paraphrase after being coupled with the auxiliary replacer; and generating another text by using the text generator.

According to the disclosure, it is possible to cope with the complication of processing while reducing the difficulty of constructing learning data.

These and other benefits are described throughout the present specification. A further understanding of the nature and advantages of the text generation concept may be realized by reference to the remaining portions of the specification and the attached drawings.

### BRIEF DESCRIPTION OF THE DRAWINGS

FIG. 1 is a block diagram illustrating a hardware configuration of a text generation device according to a first embodiment.

FIG. 2 is a block diagram illustrating a functional configuration of the text generation device of FIG. 1.

FIG. 3 is a table illustrating an example of replacement information stored in a replacement information DB of FIG. 2.

FIG. 4 is a table illustrating an example of replacement teacher data stored in a replacement teacher data DB of FIG. 2.

FIG. 5 is a table illustrating an example of generation information stored in a generation information DB of FIG. 2.

FIG. 6 is a table illustrating an example of generation teacher data stored in a generation teacher data DB of FIG. 2.

FIG. 7 is a flowchart illustrating operations of the text generation device of FIG. 2.

FIG. 8 is a flowchart illustrating replacement information collection processing of FIG. 7.

FIG. 9 is a flowchart illustrating auxiliary replacer teacher data generation processing of FIG. 7.

FIG. 10 is a flowchart illustrating auxiliary replacer generation processing of FIG. 7.

FIG. 11 is a flowchart illustrating text generation information collection processing of FIG. 7.

FIG. 12 is a flowchart illustrating text generator teacher data generation processing of FIG. 7.

FIG. 13 is a flowchart illustrating text generator generation processing of FIG. 7.

FIG. 14 is a block diagram illustrating a configuration example of a learning-completed model according to a second embodiment.

FIG. 15 is a block diagram illustrating a configuration example of a learning-completed model according to a third embodiment.

FIG. 16 is a block diagram illustrating an example of learning data used by a learning-completed model of FIG. 15 for paraphrase generation.

FIG. 17 is a block diagram illustrating a configuration example of a learning-completed model according to a fourth embodiment.

### DESCRIPTION OF THE EMBODIMENTS

Embodiments will be described with reference to the drawings. It should be noted that the embodiments described below do not limit the invention according to the claims, and all of the elements and combinations thereof described in the embodiments are not necessarily essential to the solution to the problem.

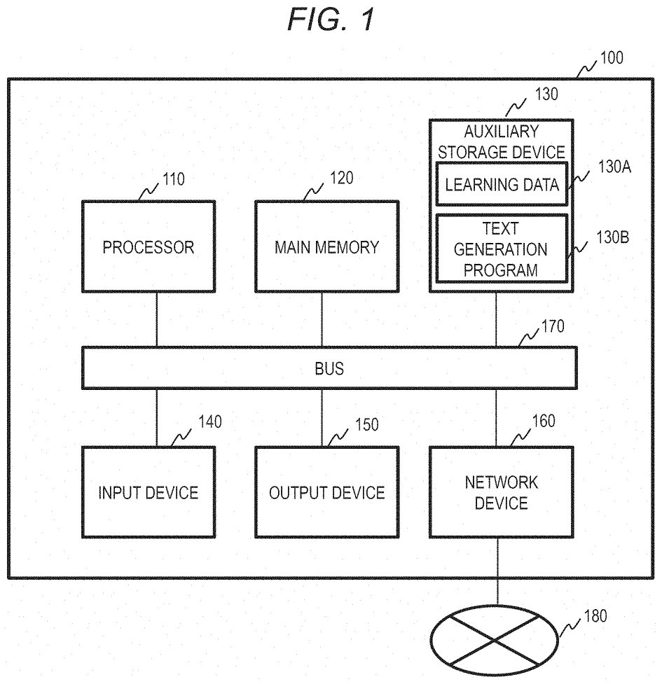

FIG. 1 is a block diagram illustrating a hardware configuration of a text generation device according to a first embodiment.

In FIG. 1, a text generation device 100 includes a processor 110, a main memory 120, an auxiliary storage device 130, an input device 140, an output device 150, and a network device 160. The processor 110, the main memory 120, the auxiliary storage device 130, the input device 140, the output device 150, and the network device 160 are connected one another via a bus 170. The main memory 120 and the auxiliary storage device 130 can be accessed by the processor 110.

The processor 110 is hardware that controls operations of the entire text generation device 100. The processor 110 may be a Central Processing Unit (CPU) or a Graphics Processing Unit (GPU). The processor 110 may be a single core processor or a multi-core processor. The processor 110 may include a hardware circuit (for example, a Field-Programmable Gate Array (FPGA) or an Application Specific Integrated Circuit (ASIC)) that performs a part or all of the processing.

The main memory 120 may be configured with, for example, a semiconductor memory such as an SRAM or a DRAM. In the main memory 120, a program being executed by the processor 110 may be stored, or a work area for the processor 110 to execute the program may be provided.

The auxiliary storage device 130 is a storage device having a large storage capacity, and is, for example, a hard disk drive or a Solid State Drive (SSD). The auxiliary storage device 130 can store data that is used for execution of a program or used for execution files of various programs. In the auxiliary storage device 130, learning data 130A and a text generation program 130B can be stored. The learning data 130A may be collected from a network 180 via the network device 160, or may be directly input by a user via the input device 140. The text generation program 130B may be software that can be installed in the text generation device 100, or may be incorporated in the text generation device 100 as firmware.

The input device 140 is, for example, a keyboard, a mouse, a touch panel, a card reader, or an audio input device. The output device 150 is, for example, a screen display device (for example, a liquid crystal monitor, an organic Electro Luminescence (EL) display, and a graphic card), an audio output device (for example, a speaker), or a printing device.

The network device 160 is hardware having a function of controlling communication with the outside. The network device 160 is connected to the network 180. The network 180 may be a Wide Area Network (WAN) such as the Internet, a Local Area Network (LAN) such as WiFi or Ethernet (registered trademark), or a combination of the WAN and the LAN.

The processor 110 reads the learning data 130A and the text generation program 130B into the main memory 120, and uses the learning data 130A to execute the text generation program 130B. At this time, the processor 110 can generate an auxiliary replacer that is made to learn pairs of elements obtained by segmenting a text, generate a text generator that is made to learn texts before and after paraphrase after coupling with the auxiliary replacer, and generate another text by using the text generator. The element obtained by segmenting the text is, for example, a token. A token is a minimum unit which has meaning and which can be extracted from a text, and is, for example, a word or a fragment of a word.

The execution of the text generation program 130B may be shared by a plurality of processors or computers. Alternatively, the processor 110 may instruct a cloud computer or the like to execute all or a part of the text generation program 130B via the network 180, and receive an execution result.

Here, the auxiliary replacer can be provided with a part of functions required for generating a text with a low superficial similarity. Therefore, by coupling the auxiliary replacer with the text generator, functions to be obtained by the text generator can be limited to a part of the functions required for generating a text with a low superficial similarity. Therefore, the amount of data required for learning of the text generator can be reduced, and a text generation method can be provided that allows learning of paraphrase generation having a low superficial similarity even in a situation where a large amount of teacher data having a low superficial similarity cannot be prepared.

A “low superficial similarity” of two texts indicates that words or styles of the two texts differ greatly. Specifically, among texts containing different elements, texts that do not have the same set of elements by replacement of one element can be defined as having a low superficial similarity. That is, a superficial similarity of two texts x and y can be defined as follows.

A text segmentation method D is set. The text segmentation method D can be determined focusing on at least one of a morpheme, a phrase structure, a dependency structure, a named entity, and a Sub word unit. A morpheme is a minimum unit of an expression element that has meaning. A phrase structure indicates a semantic and functional relationship between adjacent phrases obtained by segmenting a text. A dependency structure indicates a dependency relationship between words. A named entity is an expression of a proper noun (such as a person's name, a name of an organization, or a name of a place), a date, time, a quantity, the amount of money, or the like. A Sub word unit is an element of a smaller unit that is obtained by further segmenting one word when a frequency of appearance of the word is low. The Sub word unit is also referred to as a sentence piece, a word piece or the like in accordance with a difference of an algorithm or implementation.

Next, each of the texts x and y is segmented with the text segmentation method D, and the following sets X and Y are defined.

X=(x1,x2,x3, . . . xn)

Y=(y1,y2,y3, . . . ym)

Here, x1, x2, x3, . . . , xn (n is a positive integer) are elements of the text x, and y1, y2, y3, . . . ym (m is a positive integer) are elements of the text y.

In a case where all the elements of the set X are same as all the elements of the set Y, or in a case where the set X are same as the set Y by replacement of one element in the set X, the sets X and Y are defined as having a high superficial similarity. In other cases, the sets X and Y are defined as having a low superficial similarity.

When the superficial similarity is low, there are two or more different words between the two texts, and there are two or more differences in the minimum unit having meaning. For this reason, it is difficult to determine whether the meaning or intent is the same between texts having a low superficial similarity, and it is difficult to acquire and collect a pair of texts that have a low superficial similarity and that have the same meaning or intent. On the other hand, when the superficial similarity is high, there is only one different word between the two texts, and there is only one difference in the minimum unit having meaning. For this reason, between texts having a high superficial similarity, difficulty in determining whether the meaning or intent is the same is reduced, and it is relatively easy to acquire and collect a pair of texts that have a high superficial similarity and that have the same meaning or intent.

The learning data for generating the auxiliary replacer is pairs of elements obtained by segmenting a text, and there is only one difference in the minimum unit having meaning. Therefore, it is possible to facilitate collection of the learning data for generating the auxiliary replacer, and the text generator only needs to learn a part of functions required for generating a text with a low superficial similarity, so that it is possible to reduce the difficulty of data collection required for learning the text with a low superficial similarity.

For example, there is only one different word between two texts of “I want to confirm the location of the station” and “I want to know the location of the station”. Therefore, it can be easily determined whether the meaning or intent of the two texts is the same, and it is easy to collect such two texts in a large amount as learning data. Meanwhile, there are two or more different words between two texts of “Where is the station” and “I want to take the train”. Therefore, it is difficult to determine whether the meaning or intent of the two texts is the same, and it is difficult to collect such two texts in a large amount as learning data.

In this case, the two texts of “Where is the station” and “I want to take the train” are respectively segmented into elements, and a role of the auxiliary replacer is determined. At this time, an auxiliary replacer A that enables “take the train” to be replaced with “station”, and an auxiliary replacer B that enables “I want to” to be replaced with “Where is” are defined. A role of the auxiliary replacer A is to convert action content to an action target. A role of the auxiliary replacer B is to convert a desiderative sentence to an interrogative sentence.

Before-replacement information and after-replacement information corresponding to each role of the auxiliary replacers A and B is collected. Further, the before-replacement information and the after-replacement information is used to generate teacher data to be used in machine learning of the auxiliary replacers A and B. Further, the teacher data is used to generate the auxiliary replacers A and B.

Next, the auxiliary replacers A and B are coupled with a text generator that has not performed learning. Further, before-generation information and after-generation information used in learning of the text generator is collected. The before-generation information is the text of “I want to take the train”, and the after-generation information is the text of “Where is the station”. Further, the before-generation information and the after-generation information are used to generate teacher data to be used in machine learning of the text generator. Further, the teacher data is used to generate the text generator. Further, by using a learning-completed text generator, a response text is generated in response to an input text from a user terminal.

Accordingly, the text generator can utilize processing of the auxiliary replacer at the time of learning and at the time of generating a text. At this time, there are three functions to be acquired by the text generator including: “converting action content to action target”, “converting desiderative sentence to interrogative sentence”, and “selecting and utilizing the two functions corresponding to an input text”. However, since the two functions of “converting action content to action target” and “converting desiderative sentence to interrogative sentence” are obtained by being coupled with the auxiliary replacer, the text generator only needs to acquire the function of “selecting and utilizing the two functions corresponding to an input text”.

Accordingly, functions to be acquired by the text generator can be limited to a part of the functions required for generating a text with a low superficial similarity. Therefore, the amount of data that is required for learning of a text with a low superficial similarity and that is difficult to collect can be reduced, and even in a situation where a large amount of teacher data cannot be prepared, learning of paraphrase generation having a low superficial similarity is possible in the End-to-End architecture.

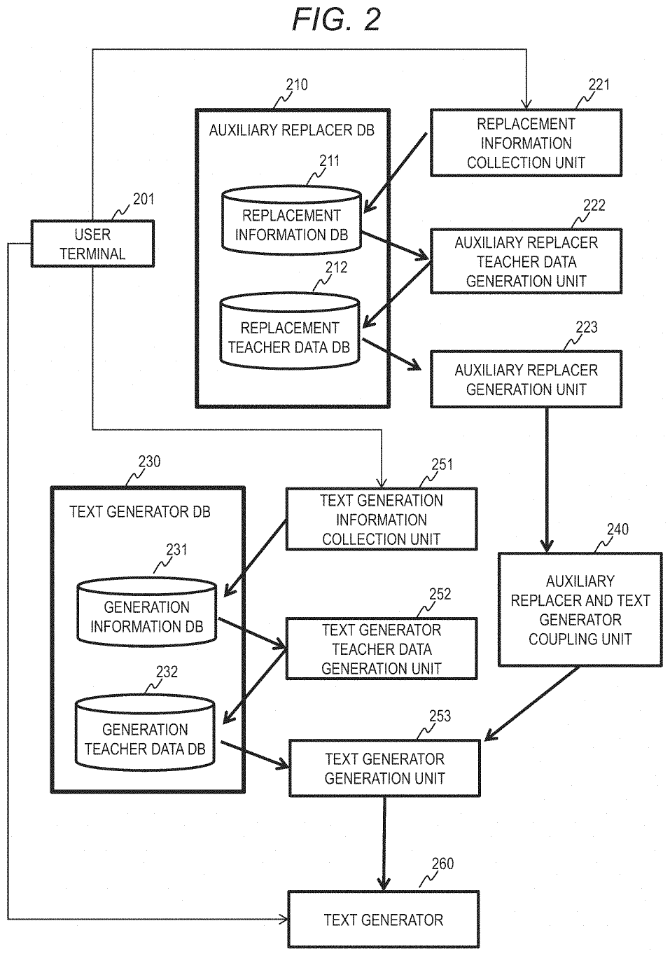

FIG. 2 is a block diagram illustrating a functional configuration of the text generation device of FIG. 1. It should be noted that, in the following description, when “xx unit” is described as an operation subject, it means that the processor 110 of FIG. 1 reads out the “xx unit” that is a program from the auxiliary storage device 130, and loads the program into the main memory 120 to realize the function of the “xx unit”.

In FIG. 2, the text generation device 100 includes an auxiliary replacer Data Base (DB) 210, a text generator DB 230, a replacement information collection unit 221, an auxiliary replacer teacher data generation unit 222, an auxiliary replacer generation unit 223, an auxiliary replacer and text generator coupling unit 240, a text generation information collection unit 251, a text generator teacher data generation unit 252, a text generator generation unit 253, and a text generator 260. The text generation device 100 is connected to a user terminal 201.

The auxiliary replacer DB 210 stores data required for generating an auxiliary replacer. The auxiliary replacer DB 210 includes a replacement information DB 211 and a replacement teacher data DB 212. The replacement information DB 211 stores the before-replacement information and the after-replacement information for generating the auxiliary replacer. The before-replacement information and the after-replacement information are, for example, pairs of tokens obtained by segmenting a text. The replacement teacher data DB 212 stores teacher data used for machine learning of the auxiliary replacer.

The text generator DB 230 stores data required for generating a text generator. The text generator DB 230 includes a generation information DB 231 and a generation teacher data DB 232. The generation information DB 231 stores the before-generation information and the after-generation information for generating the text generator. The generation teacher data DB 232 stores teacher data used for machine learning of the text generator.

The replacement information collection unit 221 receives input from the user terminal 201 and determines a role of the auxiliary replacer. A plurality of auxiliary replacers may be provided for each role. For example, with respect to the two auxiliary replacers A and B, the role of “converting action content to action target” can be given to the auxiliary replacer A, and the role of “converting desiderative sentence to interrogative sentence” can be given to the auxiliary replacer B. Further, the replacement information collection unit 221 collects the before-replacement information and the after-replacement information corresponding to each role and stores the collected information in the replacement information DB 211.

The auxiliary replacer teacher data generation unit 222 generates replacement teacher data used for machine learning of the auxiliary replacer, based on a reference result of the replacement information DB 211, and stores the replacement teacher data in the replacement teacher data DB 212. The auxiliary replacer generation unit 223 generates an auxiliary replacer based on a reference result of the replacement teacher data DB 212. The auxiliary replacer and text generator coupling unit 240 couples the auxiliary replacer generated by the auxiliary replacer generation unit 223 with a text generator that has not performed learning.

The text generation information collection unit 251 receives input from the user terminal 201, collects before-generation information and after-generation information of a text, and stores the collected information in the generation information DB 231. The text generator teacher data generation unit 252 generates generation teacher data used for machine learning of the text generator, based on a reference result of the generation information DB 231, and stores the generation teacher data in the generation teacher data DB 232. The text generator generation unit 253 generates the text generator 260 based on a reference result of the generation teacher data DB 232. The text generator 260 generates a response text in response to an input text from the user terminal 201. At this time, the text generator 260 can generate a response text with a low superficial similarity with respect to the input text.

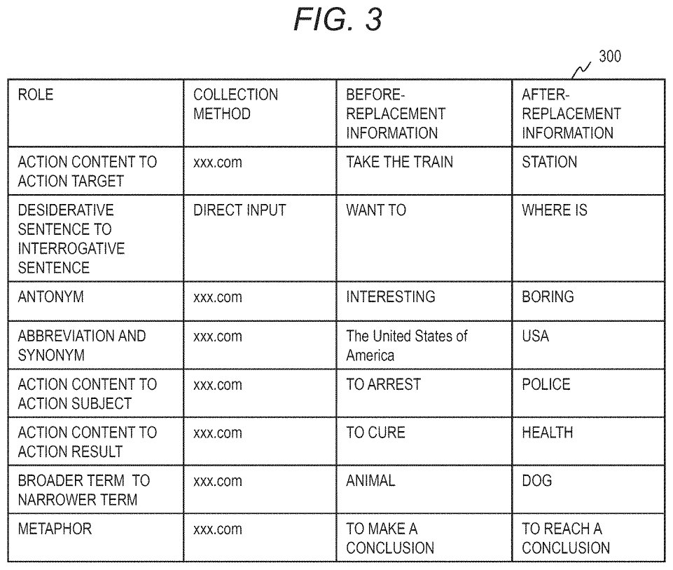

FIG. 3 is a table illustrating an example of the replacement information stored in the replacement information DB of FIG. 2.

In FIG. 3, data 300 of the replacement information DB 211 includes one or more “replacement information” records. The “replacement information” record includes a plurality of fields such as a field of “role” and a field of “collection method”. A field of “before-replacement information” stores element information of a text before replacement. A field of “after-replacement information” stores element information of the text after replacement. A field of “role” stores information for identifying a role of corresponding replacement.

The role is, for example, conversion from action content to an action target, conversion from a desiderative sentence to an interrogative sentence, an antonym, an abbreviation or a synonym, conversion from action content to an action subject, conversion from action content to an action result, conversion from a broader term to a narrower term, and a metaphor. In the role of “action content to action target”, for example, “take the train” is stored as the before-replacement information, and “station” is stored as the after-replacement information. In the role of “desiderative sentence to interrogative sentence”, for example, “I want to” is stored as the before-replacement information, and “Where is” is stored as the after-replacement information. In the role of “antonym”, for example, “interesting” is stored as the before-replacement information, and “boring” is stored as the after-replacement information.

A field of “collection method” stores information for identifying methods used to collect the “replacement information” records. When the collection method is direct input from the user terminal 201, “direct input” is stored. When the collection method is using language resources of a Web site via the network 180 of FIG. 1, an address of the Web site is stored.

For example, when crawling is used for collection, collection of the before-replacement information and the after-replacement information is easier than collection of texts before and after paraphrase which have a low superficial similarity. In addition, in a case of direct input by the user, before-replacement information and after-replacement information is more likely to occur than texts before and after paraphrase which have a low superficial similarity. Therefore, learning data to be used for learning of the auxiliary replacer can be easily collected.

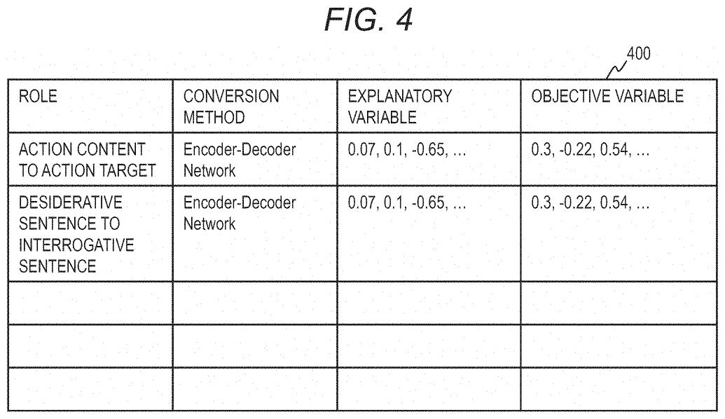

FIG. 4 is a table illustrating an example of the replacement teacher data stored in the replacement teacher data DB of FIG. 2.

In FIG. 4, data 400 of the replacement teacher data DB 212 includes one or more “replacement teacher data” records. The “replacement teacher data” record includes a plurality of fields such as a field of “role” and a field of “conversion method”.

A field of “role” stores information for identifying the role of a replacer that can use the record as teacher data of machine learning. For example, when the field of “role” stores “interrogative sentence to desiderative sentence”, the record can be used for learning of the auxiliary replacer in which the role of “interrogative sentence to desiderative sentence” is defined.

A field of “conversion method” stores information for identifying a method used to convert the before-replacement information of the “replacement information” record into an explanatory variable. In addition, the field of “conversion method” stores information for identifying the method used to convert the after-replacement information of the “replacement information” record into an objective variable. A field of “explanatory variable” stores a result of converting the before-replacement information of the “replacement information” record into the explanatory variable by using a method stored in the field of “conversion method”. A field of “objective variable” stores a result of converting the after-replacement information of the “replacement information” record into the objective variable by using a method stored in the field of “conversion method”. The explanatory variable and objective variable can be represented by vector data.

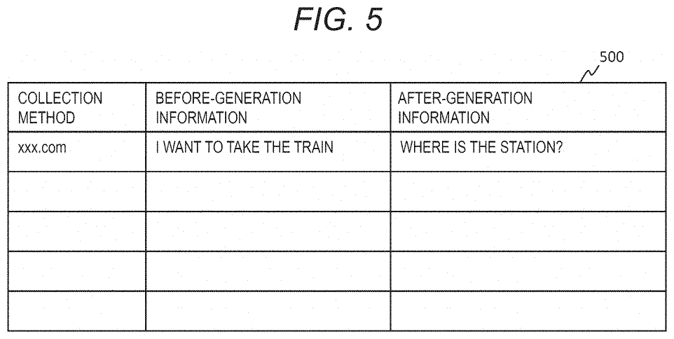

FIG. 5 is a table illustrating an example of the generation information stored in the generation information DB of FIG. 2.

In FIG. 5, data 500 of the generation information DB 231 includes one or more “generation information” records. The “generation information” record includes a plurality of fields such as a field of “collection method” and a field of “before-generation information”.

The field of “collection method” stores information for identifying a method used to collect the “generation information” record. When the collection method is direct input from a user terminal, “direct input” is stored. When the collection method is using language resources of an external Web site via the communication network, an address of the Web site is stored. The field of “before-generation information” stores before-generation text information. A field of “after-generation information” stores after-generation text information.

With respect to the before-generation information and the after-generation information, texts before and after paraphrase can be used. With respect to the before-generation information and the after-generation information, texts having a low superficial similarity are preferable. However, the before-generation information and the after-generation information may be set regardless of a relationship with the superficial similarity.

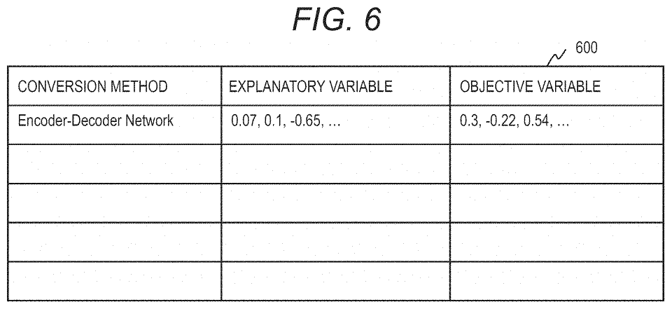

FIG. 6 is a table illustrating an example of the generation teacher data stored in the generation teacher data DB of FIG. 2.

In FIG. 6, data 600 of the generation teach data DB 232 includes one or more “generation teacher data” records. The “generation teacher data” record includes a plurality of fields such as a field of “conversion method” and a field of “explanatory variable”. The field of “conversion method” stores information for identifying a method used to convert the before-generation information of the “generation information” record into an explanatory variable. In addition, the field of “conversion method” stores information for identifying a method used to convert the after-generation information of the “generation information” record into an objective variable.

The field of “explanatory variable” stores a result of converting the before-generation information of the “generation information” record into the explanatory variable by using a method stored in the field of conversion method. A field of “objective variable” stores a result of converting the after-generation information of the “generation information” record into the objective variable by using a method stored in the field of conversion method. The explanatory variable and objective variable can be represented by vector data.

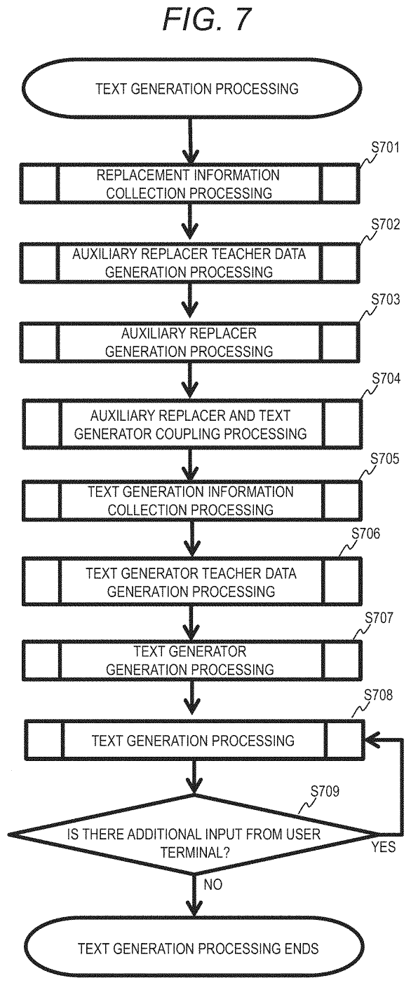

FIG. 7 is a flowchart illustrating operations of the text generation device of FIG. 2.

In FIG. 7, the replacement information collection unit 221 of FIG. 2 receives input from the user terminal 201 and performs replacement information collection processing (S701).

Next, the auxiliary replacer teacher data generation unit 222 generates replacement teacher data for generating an auxiliary replacer (S702). Next, the auxiliary replacer generation unit 223 generates the auxiliary replacer based on the replacement teacher data (S703). Next, the auxiliary replacer and text generator coupling unit 240 couples the auxiliary replacer with a text generator that has not performed learning (S704).

Next, the text generation information collection unit 251 performs text generation information collection processing (S705). Next, the text generator teacher data generation unit 252 generates generation teacher data for generating the text generator 260 (S706). Next, the text generator generation unit 253 generates the learning-completed text generator 260 based on the generation teacher data (S707). Next, the text generator 260 generates a response text in response to the input text from the user terminal 201 (S708).

Next, the text generator 260 determines whether there is an additional input from the user terminal 201. If there is an additional input from the user terminal 201 (S709: YES), the text generator 260 returns to step 708 and generates a response text in response to the input text. On the other hand, if there is no additional input from the user terminal 201 (S709: NO), the text generator 260 ends the text generation processing.

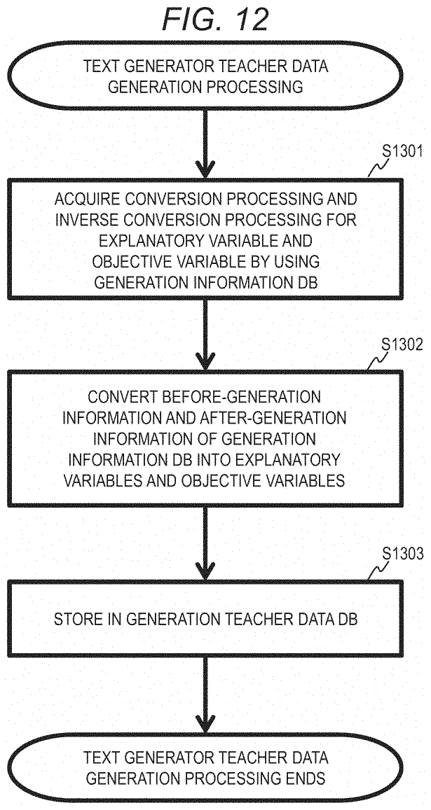

The text generator 260 receives input of an explanatory variable of an End-to-End model. For this reason, the input text is converted into the explanatory variable with a conversion method acquired in step 1301 of FIG. 12, and then the explanatory variable is input to the End-to-End model. Further, the text generator 260 outputs an objective variable of the End-to-End model. For this reason, the objective variable is converted into a response text with an inverse conversion method acquired in step 1301 of FIG. 12, and then the response text is output to the user terminal 201.

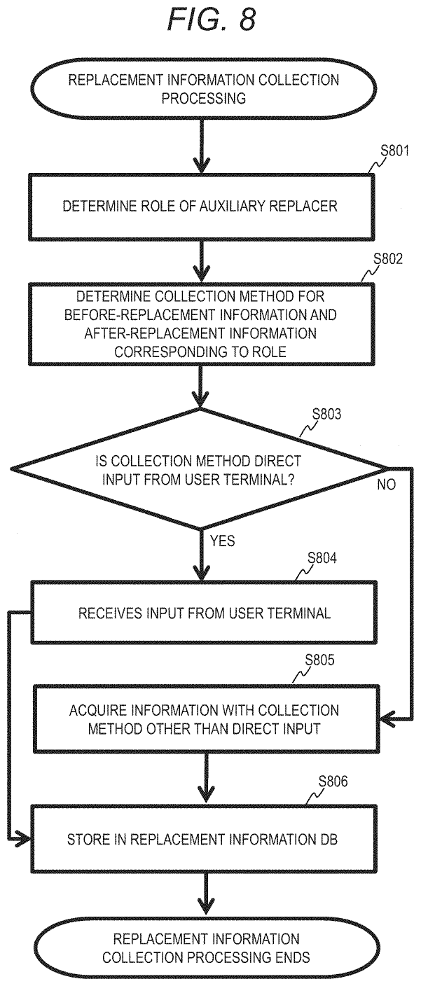

FIG. 8 is a flowchart illustrating the replacement information collection processing of FIG. 7.

In FIG. 8, the replacement information collection unit 221 of FIG. 2 determines roles of the auxiliary replacer (S801). Next, the replacement information collection unit 221 determines a collection method for before-replacement information and after-replacement information corresponding to each role (S802).

Next, the replacement information collection unit 221 determines whether the collection method is direct input from the user terminal 201. If the collection method is direct input from the user terminal 201 (S803: YES), the replacement information collection unit 221 receives input from the user terminal 201 (S804). If the collection method is not direct input from the user terminal 201 (S803: NO), the replacement information collection unit 221 acquires the before-replacement information and after-replacement information with a collection method other than direct input (S805). Next, the replacement information collection unit 221 stores the collected before-replacement information and after-replacement information in the replacement information DB 211 (S806).

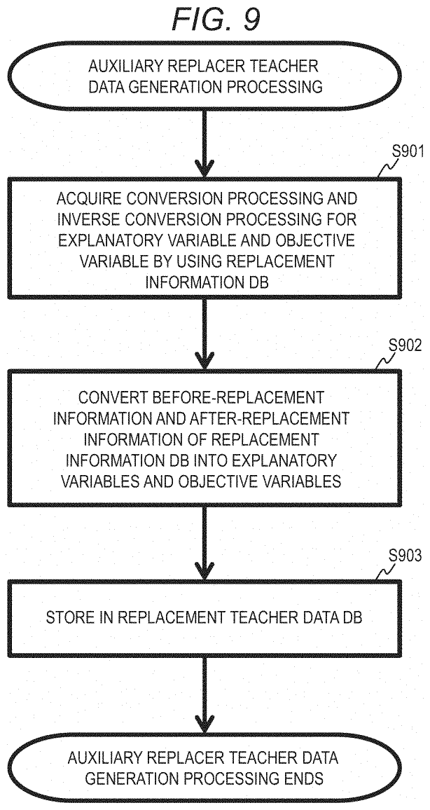

FIG. 9 is a flowchart illustrating the auxiliary replacer teacher data generation processing of FIG. 7.

In FIG. 9, the auxiliary replacer teacher data generation unit 222 of FIG. 2 refers to the replacement information DB 211, and acquires conversion processing and inverse conversion processing for the explanatory variable and the objective variable (S901).

Next, the auxiliary replacer teacher data generation unit 222 converts the before-replacement information and the after-replacement information acquired from the replacement information DB 211 into explanatory variables and objective variables (S902). Next, the auxiliary replacer teacher data generation unit 222 stores the explanatory variables and objective variables in the replacement teacher data DB 212 (S903).

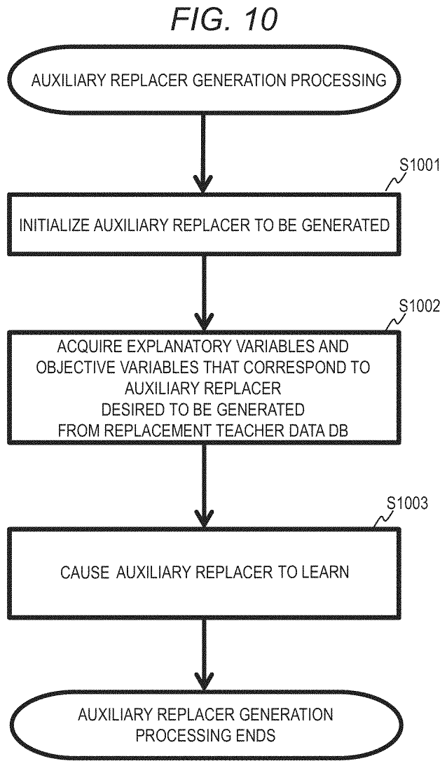

FIG. 10 is a flowchart illustrating the auxiliary replacer generation processing of FIG. 7.

In FIG. 10, the auxiliary replacer generation unit 223 of FIG. 2 initializes an auxiliary replacer to be generated (S1001).

Next, the auxiliary replacer generation unit 223 acquires, from the replacement teacher data DB 212, explanatory variables and objective variables corresponding to the auxiliary replacer that is desired to be generated as replacement teacher data (S1002). Next, the auxiliary replacer generation unit 223 causes the auxiliary replacer to learn based on the acquired replacement teacher data (S1003).

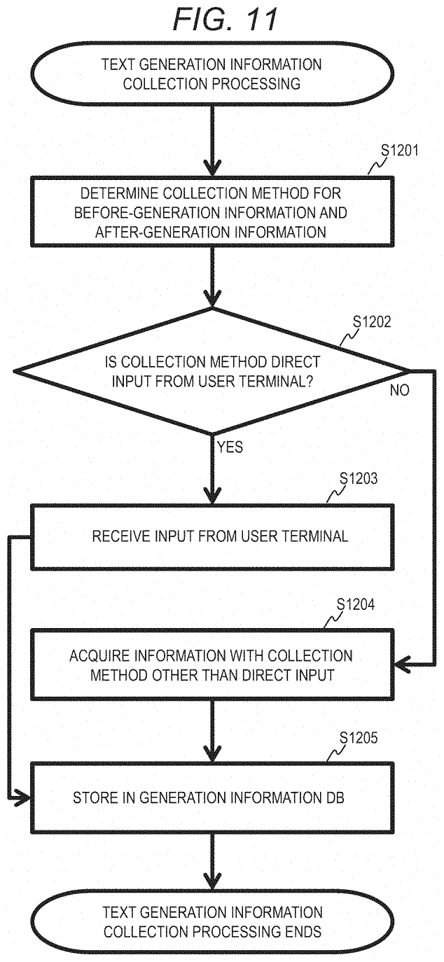

FIG. 11 is a flowchart illustrating the text generation information collection processing of FIG. 7.

In FIG. 11, the text generation information collection unit 251 of FIG. 2 determines a collection method for before-generation information and after-generation information (S1201).

Next, the text generation information collection unit 251 determines whether the collection method is direct input from the user terminal 201. If the collection method is direct input from the user terminal 201 (S1202: YES), the text generation information collection unit 251 receives input from the user terminal 201 (S1203). If the collection method is not direct input from the user terminal 201 (S1203: NO), the text generation information collection unit 251 acquires before-generation information and after-generation information with a collection method other than direct input (S1204). Next, the text generation information collection unit 251 stores the collected before-generation information and after-generation information in the generation information DB 231 (S1205).

FIG. 12 is a flowchart illustrating the text generator teacher data generation processing of FIG. 7.

In FIG. 12, the text generator teacher data generation unit 252 of FIG. 2 refers to the generation information DB 231, and acquires the conversion processing and the inverse conversion processing for the explanatory variable and the objective variable (S1301). Next, the text generator teacher data generation unit 252 converts the before-generation information and the after-generation information acquired from the generation information DB 231 into explanatory variables and objective variables (S1302). Next, the text generator teacher data generation unit 252 stores the explanatory variables and objective variables in the generation teacher data DB 232 (S1303).

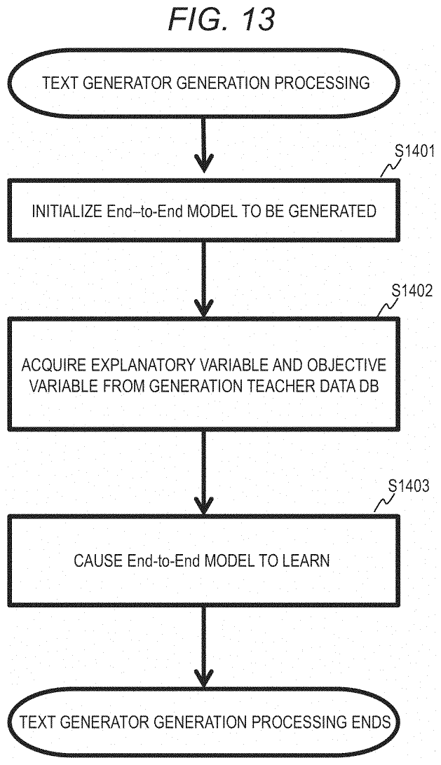

FIG. 13 is a flowchart illustrating the text generator generation processing of FIG. 7.

In FIG. 13, the text generator generation unit 253 of FIG. 2 initializes an End-to-End model to be generated (S1401).

Next, explanatory variables and objective variables corresponding to the End-to-End model to be generated are acquired as generation teacher data from the generation teacher data DB 232 (S1402). Next, the text generator generation unit 253 causes the End-to-End model to learn based on the acquired generation teacher data (S1403).

It should be noted that the auxiliary replacer and the text generator described above can both be implemented by a neural network. At this time, by replacing a part of a neural network of the text generator with a neural network of the auxiliary replacer, the auxiliary replacer can be coupled with the text generator. Hereinafter, a configuration example in which both the auxiliary replacer and the text generator are implemented by neural networks will be described.

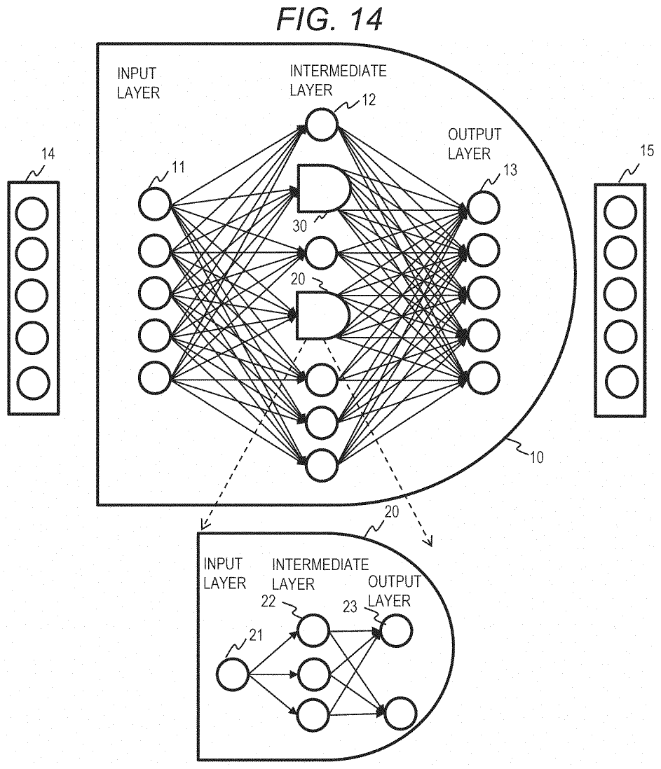

FIG. 14 is a block diagram illustrating a configuration example of a learning-completed model according to a second embodiment.

In FIG. 14, the learning-completed model includes neural networks 10, 20, and 30. The neural network 10 includes an input layer, an intermediate layer, and an output layer. The input layer of the neural network 10 includes nodes 11, the intermediate layer of the neural network 10 includes nodes 12, and the output layer of the neural network 10 includes nodes 13. In the neural network 10, output of the node 11 of the input layer is coupled with input of the nodes 12 of the intermediate layer, and output of the node 12 of the intermediate layer is coupled with input of the nodes 13 of the output layer.

The neural networks 20 and 30 are provided in the intermediate layer of the neural network 10. The neural networks 20 and 30 may have roles different from each other. Input of each of the neural networks 20 and 30 is coupled with output of the node 11 of the input layer of the neural network 10. Output of each of the neural networks 20 and 30 are coupled with input of the node 13 of the output layer of the neural network 10.

The neural network 20 includes an input layer, an intermediate layer, and an output layer. The input layer of the neural network 20 includes a node 21, the intermediate layer of the neural network 20 includes nodes 22, and the output layer of the neural network 20 includes nodes 23. Output of the node 21 of the input layer is coupled with input of the nodes 22 of the intermediate layer, and output of the node 22 of the intermediate layer is coupled with input of the nodes 23 of the output layer.

The neural networks 20 and 30 in a learning-completed state can be coupled with a neural network 10 that has not performed learning. Further, the neural network 10 can be caused to learn in a state where the learning-completed neural networks 20 and 30 are coupled with the neural network 10. An explanatory variable 14 is input into the neural network 10, and an objective variable 15 is output from the neural network 10.

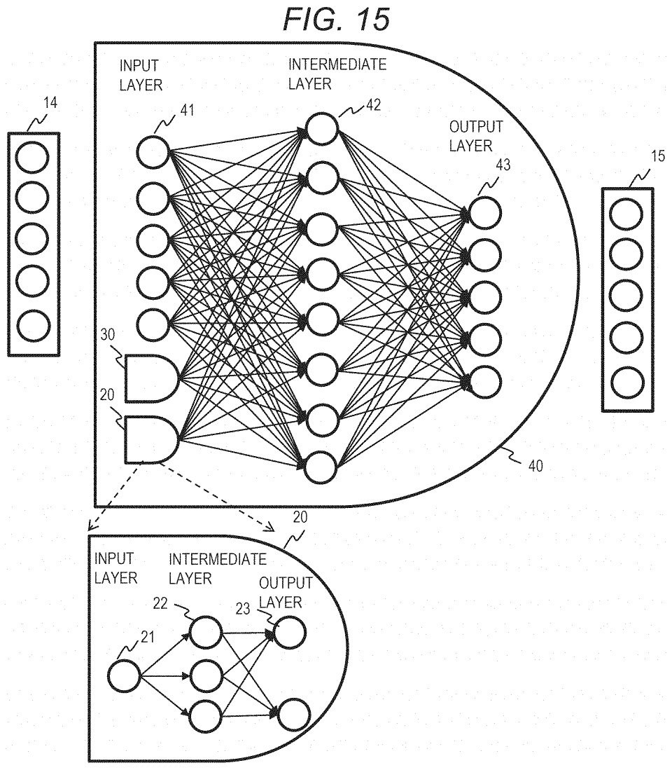

FIG. 15 is a block diagram illustrating a configuration example of a learning-completed model according to a third embodiment.

In FIG. 15, this learning-completed model includes the neural networks 20 and 30, and a neural network 40. The neural network 40 includes an input layer, an intermediate layer, and an output layer. The input layer of the neural network 40 includes nodes 41, the intermediate layer of the neural network 40 includes nodes 42, and the output layer of the neural network 40 includes nodes 43. In the neural network 40, output of the node 41 of the input layer is coupled with input of the nodes 42 of the intermediate layer, and output of the node 42 of the intermediate layer is coupled with input of the nodes 43 of the output layer.

The neural networks 20 and 30 are provided in the input layer of the neural network 40. Output of each of the neural networks 20 and 30 is coupled with input of the nodes 42 of the intermediate layer of the neural network 40.

The neural networks 20 and 30 in a learning-completed state can be coupled with a neural network 40 that has not performed learning. Further, the neural network 40 can be caused to learn in a state where the learning-completed neural networks 20 and 30 are coupled with the neural network 40. The explanatory variable 14 is input into the neural network 40, and the objective variable 15 is output from the neural network 40.

Here, by providing the neural networks 20 and 30 in the input layer of the neural network 40, the neural networks 20 and 30 can interfere with raw input data that has not been converted.

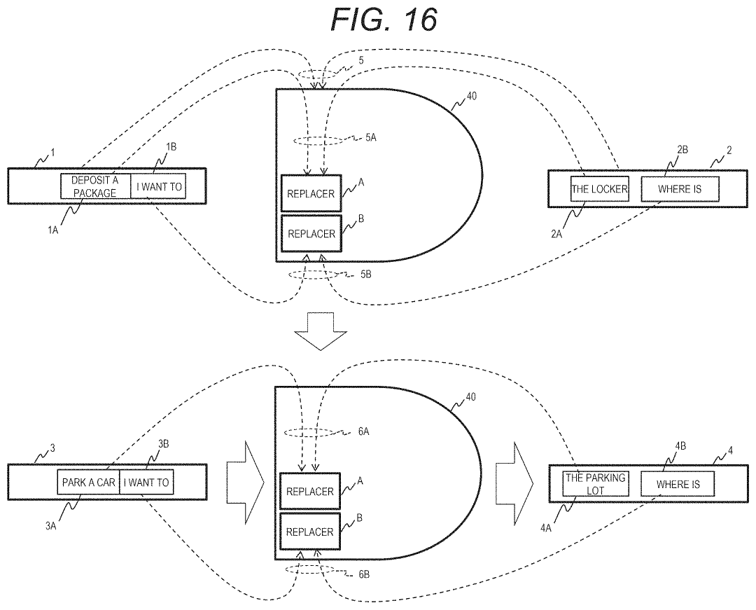

FIG. 16 is a block diagram illustrating an example of learning data used by the learning-completed model of FIG. 15 for paraphrase generation.

In FIG. 16, there are a text 1 of “I want to deposit a package” as a text before paraphrase, and a text 2 of “Where is the locker” as a text after the paraphrase. In addition, there are a text 3 of “I want to park a car” as another text before paraphrase, and a text 4 of “Where is the parking lot” as another text after the paraphrase.

At this time, the auxiliary replacer A has a role of “converting action content to action target”, and the auxiliary replacer B has a role of “converting desiderative sentence to interrogative sentence”. The auxiliary replacer A can be configured with the neural network 30 of FIG. 15, and the auxiliary replacer B can be configured with the neural network 20 of FIG. 15.

Here, an element 1A of “deposit a package”, which is obtained by segmenting the text 1 of “I want to deposit a package”, and an element 2A of “the locker”, which is obtained by segmenting the text 2 of “Where is the locker”, are provided as learning data 5A to the auxiliary replacer A, so that the auxiliary replacer A learns the function of “converting action content to action target”. An element 3A of “park a car”, which is obtained by segmenting the text 3 of “I want to park a car”, and an element 4A of “the parking lot”, which is obtained by segmenting the text 4 of “Where is the parking lot”, are provided as learning data 6A to the auxiliary replacer A, so that the auxiliary replacer A learns the function of “converting action content to action target”.

Further, an element 1B of “I want to”, which is obtained by segmenting the text 1 of “I want to deposit a package”, and an element 2B of “Where is”, which is obtained by segmenting the text 2 of “Where is the locker”, are provided as learning data 5B to the auxiliary replacer B, so that the auxiliary replacer B learns the function of “converting desiderative sentence to interrogative sentence”.

When the auxiliary replacer A, which has learned the function of “converting action content to action target”, and the auxiliary replacer B, which has learned the function of “converting desiderative sentence to interrogative sentence” are generated, the learning-completed auxiliary replacers A and B are coupled with the neural network 40 that has not performed learning.

Next, the text 1 of “I want deposit a package” and the text 2 of “Where is the locker” are provided as learning data 5 to the neural network 40, so that the neural network 40 learns a function of “selecting and utilizing functions of the auxiliary replacers A and B according to an input text”.

Next, when the text 3 of “I want to park a car” is input into the neural network 40, the auxiliary replacer A converts the element 3A of “park a car” into the element 4A “the parking lot”, and the auxiliary replacer B converts an element 3B of “I want to” into an element 4B of “Where is”. Further, the neural network 40 can output a response text of “Where is the parking lot” in response to the input text of “I want to park a car” by combining the element 4A of “the parking lot” and the element 4B “Where is”.

Here, in the End-to-End learning of the neural network 40 before the auxiliary replacers A and B are coupled, only the text 1 of “I want to deposit a package” and the text 2 of “Where is the locker” are provided as the learning data 5, only strength of correlation between keywords of “a package”, “to deposit”, “the locker”, and “Where is” is acquired, and abstract processing of replacing means to objective and replacing desire to interrogation is not acquired.

In contrast, in the End-to-End learning of the neural network 40 after the auxiliary replacers A and B are coupled, a combination of the replacement of means to objective and the replacement of desire to interrogation can be learned, and a desire, and learning efficiency of paraphrase, which has a low superficial similarity and requires abstract processing, can be improved.

A case where a nest structure, in which a part of the neural network is replaced with another neural network, is in two stages is illustrated in the embodiment described above, and alternatively the nest structure of the neural network may be in N stages (N is an integer of 2 or more).

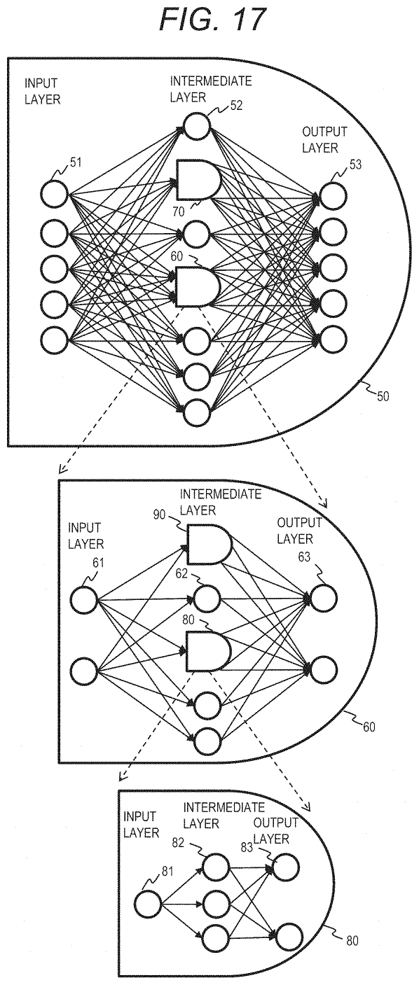

FIG. 17 is a block diagram illustrating a configuration example of a learning-completed model according to a fourth embodiment. In the example of FIG. 17, a case where the nest structure of the neural network is in three stages is shown.

In FIG. 17, the learning-completed model includes neural networks 50, 60, 70, 80, and 90. The neural network 50 includes an input layer, an intermediate layer, and an output layer. The input layer of the neural network 50 includes nodes 51, the intermediate layer of the neural network 50 includes nodes 52, and the output layer of the neural network 50 includes nodes 53. In the neural network 50, output of the node 51 of the input layer is coupled with input of the nodes 52 of the intermediate layer, and output of the node 52 of the intermediate layer is coupled with input of the nodes 53 of the output layer.

The neural networks 60 and 70 are provided in the intermediate layer of the neural network 50. The neural networks 60 and 70 may have roles different from each other. Input of each of the neural networks 60 and 70 is coupled with output of the node 51 of the input layer of the neural network 50. Output of each of the neural networks 60 and 70 is coupled with input of the nodes 53 of the output layer of the neural network 50.

The neural network 60 includes an input layer, an intermediate layer, and an output layer. The input layer of the neural network 60 includes nodes 61, the intermediate layer of the neural network 60 includes nodes 62, and the output layer of the neural network 60 includes nodes 63. Output of the node 61 of the input layer is coupled with input of the nodes 62 of the intermediate layer, and output of the node 62 of the intermediate layer is coupled with input of the nodes 63 of the output layer.

The neural networks 80 and 90 are provided in the intermediate layer of the neural network 60. The neural networks 80 and 90 may have roles different from each other. Input of each of the neural networks 80 and 90 is coupled with output of the node 61 of the input layer of the neural network 60. Output of each of the neural networks 80 and 90 is coupled with input of the nodes 63 of the output layer of the neural network 60.

The neural network 80 includes an input layer, an intermediate layer, and an output layer. The input layer of the neural network 80 includes anode 81, the intermediate layer of the neural network 80 includes nodes 82, and the output layer of the neural network 80 includes nodes 83. Output of the node 81 of the input layer is coupled with input of the nodes 82 of the intermediate layer, and output of the node 82 of the intermediate layer is coupled with input of the nodes 83 of the output layer.

The neural networks 80 and 90 in a learning-completed state can be coupled with the neural network 60 that has not performed learning. Further, the neural network 60 can be caused to learn in a state where the learning-completed neural networks 80 and 90 are coupled with the neural network 60. Further, the neural networks 60 and 70 in a learning-completed state can be coupled with the neural network 50 that has not performed learning. Further, the neural network 50 can be caused to learn in a state where the learning-completed neural networks 60 and 70 are coupled with the neural network 50.

As described above, according to the embodiment described above, a part of the function realized by the neural network can be provided in another neural network by coupling another learning-completed neural network with a part of the neural network. At this time, the collection of learning data for learning a part of the functions to be realized by the neural network can be made easier than the collection of learning data for learning all of the functions to be realized by the neural network, and it is possible to cope with the complication of the functions realized by the neural network while reducing the difficulty in collecting the learning data.

Although a case where the neural network described above is used for paraphrase generation is shown, the neural network may be used for processing such as image processing, character recognition processing, speech recognition processing, face authentication processing, and automatic driving in addition to paraphrase generation. The neural network described above can be used in all technical fields to which Artificial Intelligence (AI) can be applied.

Although the embodiments of the invention have been described above, these embodiments are merely examples, and the technical scope of the invention is not limited thereto. For example, the auxiliary replacer and the text generator may not be implemented by a neural network. Conversion from the replacement information or the generation information to the teacher data may not be realized by an Encoder-Decoder network.

What is claimed is:

1. A text generation method, comprising:
generating an auxiliary replacer that is made to learn pairs of elements obtained by segmenting a text;
generating a text generator that is made to learn texts before and after paraphrase after being coupled with the auxiliary replacer; and
generating another text by using the text generator.

2. The text generation method according to claim 1, further comprising:
collecting a pair of elements obtained by segmenting the text;
generating replacement teacher data to be used for learning of the auxiliary replacer based on the pair of elements;
generating the auxiliary replacer based on the replacement teacher data;
coupling the auxiliary replacer with a text generator that has not performed learning;
collecting the texts before and after paraphrase which are to be used for learning of the text generator;
generating generation teacher data to be used for learning of the text generator based on the texts before and after paraphrase; and
generating the text generator that is capable of performing paraphrase of the text, based on the generation teacher data.

3. The text generation method according to claim 1, wherein
when, among texts containing different elements, texts that do not have the same set of elements by replacement of one element are defined as having a low superficial similarity,
the texts before and after paraphrase have the low superficial similarity.

4. The text generation method according to claim 1, wherein
the text generator learns a combination of the pairs of elements learned by the auxiliary replacer.

5. The text generation method according to claim 1, wherein
the text generator is a neural network that includes an input layer, an intermediate layer, and an output layer, and
the auxiliary replacer is provided in the input layer or the intermediate layer of the neural network.

6. The text generation method according to claim 1, wherein
the auxiliary replacer is generated for each of roles indicated by the pairs of elements, and
a plurality of auxiliary replacers generated for each of the roles are coupled with the text generator.

7. The text generation method according to claim 6, wherein
the roles are selected from at least one of conversion from action content to an action target, conversion from a desiderative sentence to an interrogative sentence, an antonym, an abbreviation, a synonym, conversion from action content to an action subject, conversion from action content to an action result, conversion from a broader term to a narrower term, and a metaphor.

8. A text generation device, comprising:
an auxiliary replacer generation unit that generates an auxiliary replacer that is made to learn pairs of elements obtained by segmenting a text; and
a text generator generation unit that generates a text generator that is made to learn texts before and after paraphrase after being coupled with the auxiliary replacer.

9. A learning-completed model, comprising:
a first neural network; and
a second neural network that is coupled with a part of nodes of the first neural network.

10. The learning-completed model according to claim 9, wherein
the second neural network is provided in an input layer of the first neural network, and
the first neural network includes a node into which output from a node of the input layer of the first neural network and output from the second neural network is both input.

11. The learning-completed model according to claim 9, wherein
the second neural network is provided in an intermediate layer of the first neural network, and
the first neural network includes a node into which output from a node of the first neural network and output from the second neural network is both input.

12. The learning-completed model according to claim 9, wherein
the second neural network learns a part of functions to be learned by the first neural network, and
the first neural network learns a combination of the functions learned by the second neural network.

13. The learning-completed model according to claim 11, wherein
the second neural network learns a part of functions to be learned by the first neural network for each role.

14. The learning-completed model according to claim 13, wherein
when, among texts containing different elements, texts that do not have the same set of elements by replacement of one element are defined as having a low superficial similarity,
the second neural network learns pairs of elements among the texts having the low superficial similarity for each role indicated by the pairs of elements, and
the first neural network learns a combination of the pairs of elements learned by the second neural network.

15. The learning-completed model according to claim 9, further comprising:
a third neural network that is coupled with a part of nodes of the first neural network, wherein
a function of the second neural network and a function of the third neural network have roles different from each other.
